(19) United States
(12) Patent Application Publication
(10) Pub. No.: US 2016/0093926 A1
(43) Pub. Date: Mar. 31, 2016

(54) BATTERY PACK

(71) Applicant: Elite Lifestyle Products L.P., Montreal (CA)

(72) Inventor: Clifford A. Wright, San Diego, CA (US)

(21) Appl. No.: 14/869,008

(22) Filed: Sep. 29, 2015

Related U.S. Application Data
(60) Provisional application No. 62/056,873, filed on Sep. 29, 2014.

(51) Int. Cl. H01M 10/46; H02J 7/00

(52) U.S. Cl. CPC H01M 10/46; H02J 7/007; H02J 7/0052; H02J 7/0042; H01M 2220/30

(57) ABSTRACT

A battery pack comprising: a body removably connectable to a first electrical device and a second electrical device; a rechargeable battery unit; a charging connector formed in the body and being connectable to a power source for charging the battery unit; a power connector formed in the body and being connectable to the first electrical device for charging the first electrical device; a USB port formed in the body and being connectable to the second electrical device for charging the second electrical device, the USB port being positioned away from the power connector so that the battery pack be concurrently connectable to the first electrical device via the power connector and to the second electrical device via the USB port; and a control unit for charging the rechargeable battery unit and for transferring electrical power to at least one of the power connector and the USB port.

### CROSS-REFERENCE TO RELATED APPLICATIONS

The present application claims the benefit of U.S. Provisional Patent Application No. 62/056,873 filed Sep. 29, 2014, the contents of which are hereby incorporated by reference in their entirety.

### TECHNICAL FIELD

This application relates generally to battery packs and, more particularly, to removable battery packs.

### BACKGROUND

When doing activities such as outdoor camping, electrically powered devices such as flashlights need to have internal batteries so as to be used when the power grid is not readily available. Electrically powered devices typically have a built-in battery and are rechargeable by plugging the whole device into the power grid. However, the power grid is not always available when doing such types of activity. In some cases, the devices don't have a built-in battery, but instead accept disposable batteries. But, it can become cumbersome to travel with a plurality of devices all accepting different batteries, with each of them having its own mode of charging.

Therefore, there is a need for a battery pack for powering or charging at least some electrically powered devices.

### SUMMARY

According to a first broad aspect, there is provided a battery pack comprising: a body removably connectable to a first electrical device and a second electrical device; a rechargeable battery unit disposed inside the body; a charging connector formed in the body and electrically connected to the battery unit, the charging connector being connectable to a power source for charging the battery unit; a power connector formed in the body and being electrically connected to the rechargeable battery unit, the power connector being connectable to the first electrical device for transferring electrical power from the rechargeable battery unit to the first electrical device; a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and a control unit for charging the rechargeable battery unit when the charging connector is connected to the power source and for transferring electrical power to at least one of the power connector and the USB port when the battery pack is connected to at least one of the first and second electrical devices, respectively.

In one embodiment, the battery unit comprises a lithium ion battery unit.

In one embodiment, the power connector is at least one pin receiving slot.

In one embodiment, the at least one pin receiving slot comprises two rectangular slots.

In one embodiment, the power connector is disposed on a bottom of the body, and the USB port is disposed on a top of the body.

In one embodiment, the body has a rectangular shape.

In one embodiment, the charging connector is disposed on the bottom of the body adjacent to the power connector.

In one embodiment, the battery pack further comprises a locking mechanism disposed on the body, the locking mechanism being designed for securing the battery pack to the first device.

In one embodiment, the locking mechanism includes a tab slidable between an extended position and a retracted position, and a lip projecting from the tab, when in the extended position the lip being adapted to engage a corresponding recess wall of a battery receiving slot of the first device, when in the retracted position the lip being adapted to disengage the corresponding recess wall of the battery receiving slot of the first device.

In one embodiment, the locking mechanism is spring loaded.

In one embodiment, the first electrical device is a portable light device and the second electrical device is a cellular phone.

According to a second broad aspect, there is provided an assembly comprising: a power source device having a battery receiving slot and an electrical connector disposed in the battery receiving slot; and a battery pack removably insertable at least partially in the battery receiving slot of the power source device, the battery pack comprising: a body at least partially insertable into the battery receiving slot of the power source device and connectable to a first electrical device and a second electrical device; a rechargeable battery unit disposed inside the body; a charging connector formed in the body and electrically connected to the battery unit, the charging connector being connectable to the electrical connector of the power source device for charging the rechargeable battery unit; a power connector formed in the body and being electrically connected to the rechargeable battery unit, the power connector being connectable to the first electrical device for transferring electrical power from the rechargeable battery unit to the first electrical device; a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and a control unit for charging the rechargeable battery unit when the charging connector is connected to the power source and for transferring electrical power to at least one of the power connector and the USB port when the battery pack is connected to at least one of the first and second electrical devices, respectively.

In one embodiment, the battery unit comprises a lithium ion battery unit.

In one embodiment, the assembly further comprises a locking mechanism disposed on the body, the locking mechanism for removably securing the battery pack to the power source device.

In one embodiment, the power source device is a battery charger, the first electrical device is a portable light device, and the second electrical device is a cellular phone.

According to another broad aspect, there is provided an assembly comprising: a first electrical device having a battery receiving slot and an electrical connector disposed in the battery receiving slot; and a battery pack removably insertable in the battery receiving slot of the first portable device, the battery pack comprising: a body at least partially insertable into the battery receiving slot of the first electrical device and electrically connectable to the first electrical device and a second electrical device; a rechargeable battery unit disposed inside the body; a charging connector formed in the body and electrically connected to the battery unit, the charging connector being connectable to a power source device for charging the rechargeable battery unit; a power connector formed in the body and being electrically connected to the rechargeable battery unit, the power connector being connectable to the electrical connector of the first electrical device for transferring electrical power from the rechargeable battery unit to the first electrical device; a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and a control unit for charging the rechargeable battery unit when the charging connector is connected to the power source and for transferring electrical power to at least one of the power connector and the USB port when the battery pack is connected to at least one of the first and second electrical devices, respectively.

In one embodiment, the battery unit comprises a lithium ion battery unit.

In one embodiment, the assembly further comprises a locking mechanism disposed on the body, the locking mechanism being designed for removably securing the battery pack to the first electrical device.

In one embodiment, the first portable device is a portable light device and the second portable device is a cellular phone.

### BRIEF DESCRIPTION OF THE DRAWINGS

Reference is now made to the accompanying figures in which:

FIG. 1 is a perspective view of a battery pack, in accordance with an embodiment;

FIG. 2 is a left view of the battery pack of FIG. 1;

FIG. 3 is a right view of the battery pack of FIG. 1;

FIG. 4 is a top view of the battery pack of FIG. 1;

FIG. 5 is a bottom view of the battery pack of FIG. 1;

FIG. 6 is a perspective view of a top frame section of the battery pack of FIG. 1;

FIG. 7 is a front view of the top frame section of FIG. 6;

FIG. 8 is a top view of the top frame section of FIG. 6;

FIG. 9 is a perspective view of a bottom frame section of the battery pack of FIG. 1;

FIG. 10 is a left view of the bottom frame section of FIG. 9;

FIG. 11 is a bottom view of the bottom frame section of FIG. 9

FIG. 12 is a perspective view of a locking body of the battery pack of FIG. 1;

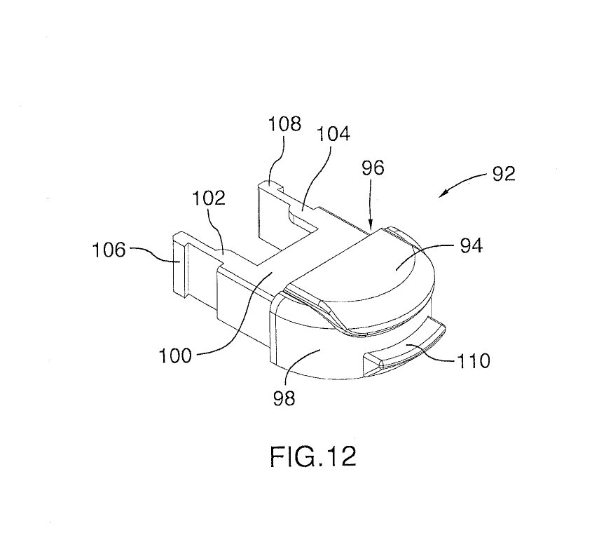

FIG. 13 is a top view of the locking body of FIG. 12;

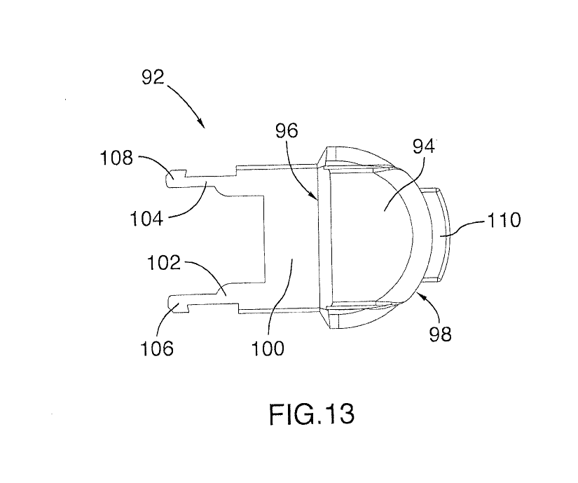

FIG. 14 is a portable light device in which a battery pack is inserted and a portable light device comprising no battery pack, in accordance with an embodiment;

FIG. 15 is a top exploded view of the battery pack of FIG. 1; and

FIG. 16 is a bottom exploded view of the battery pack of FIG. 1.

### DETAILED DESCRIPTION

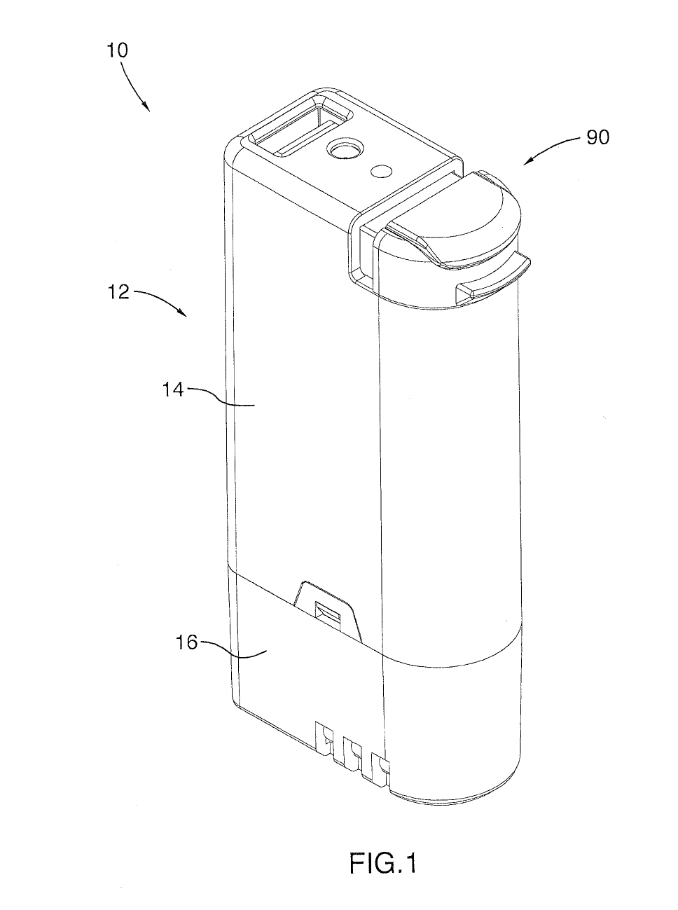

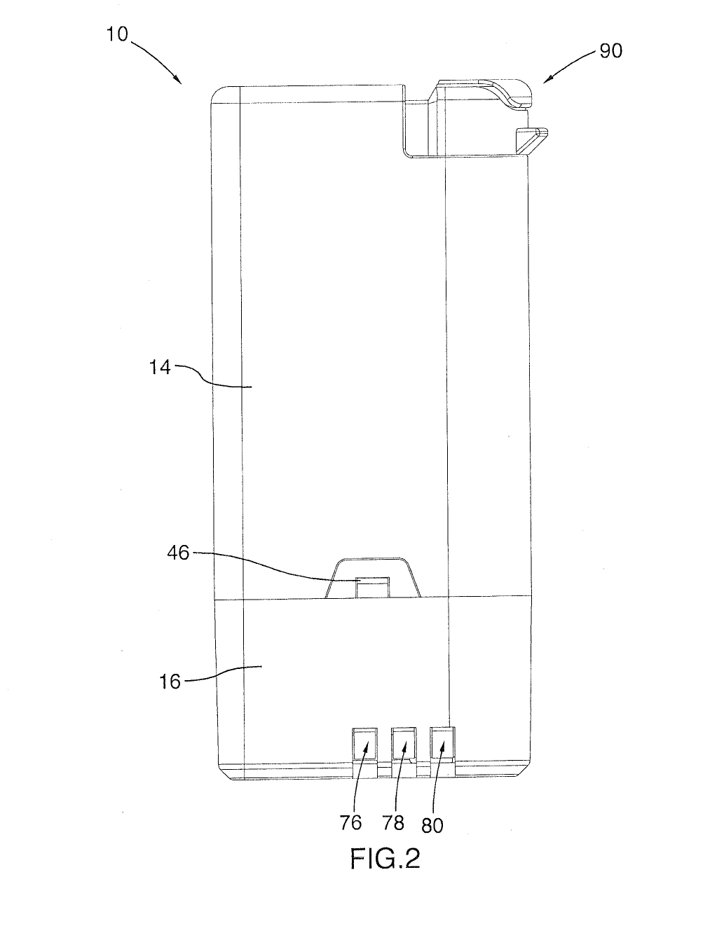

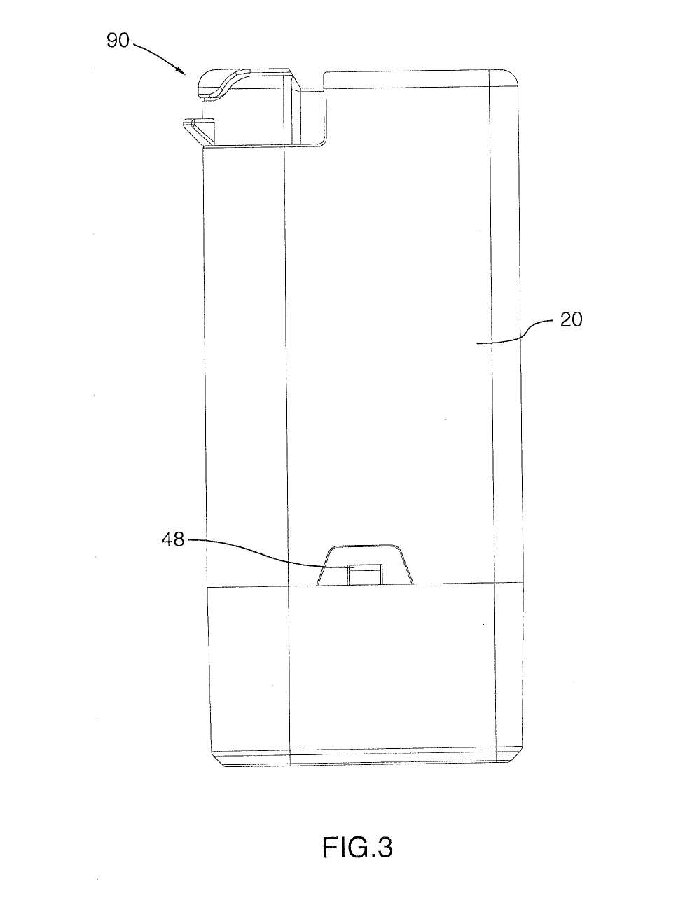

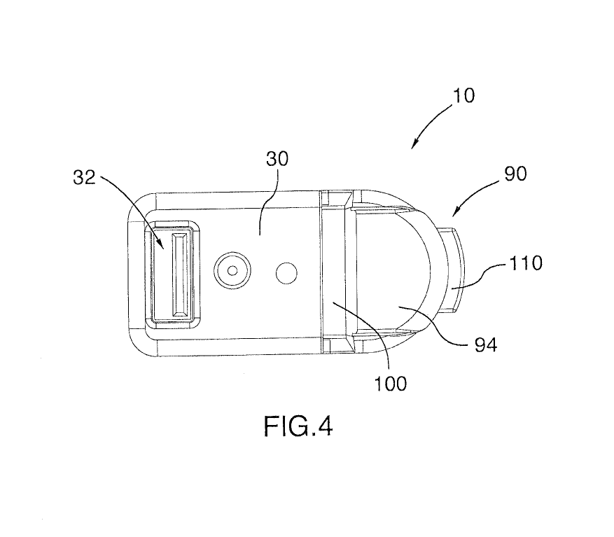

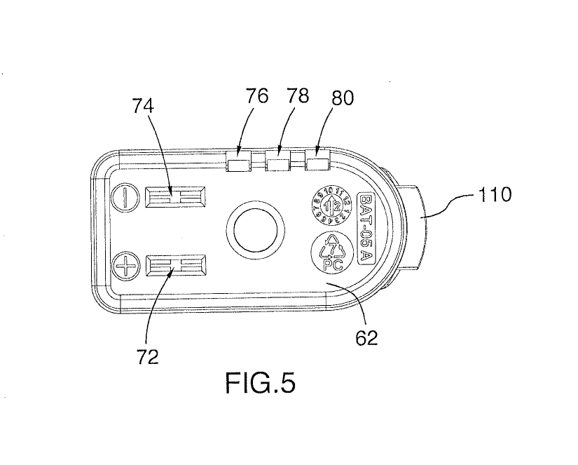

FIGS. 1 to 5 illustrate one embodiment of a battery pack 10. The battery pack 10 is a compact rechargeable battery device, which is selectively connectable and removable from a compatible electrical device to be powered or charged by the battery pack 10. The compatible device may include, for example, a lighting apparatus (an example of which is shown in FIG. 3, i.e. a portable light 100), heated garment, other camping gears, or the like. In one embodiment, the battery pack 10 may fit more than one type of compatible device. The battery pack 10 may comprise any adequate type of batteries such as a lithium ion battery, a lithium titanate battery, a nickel zinc battery, and/or the like.

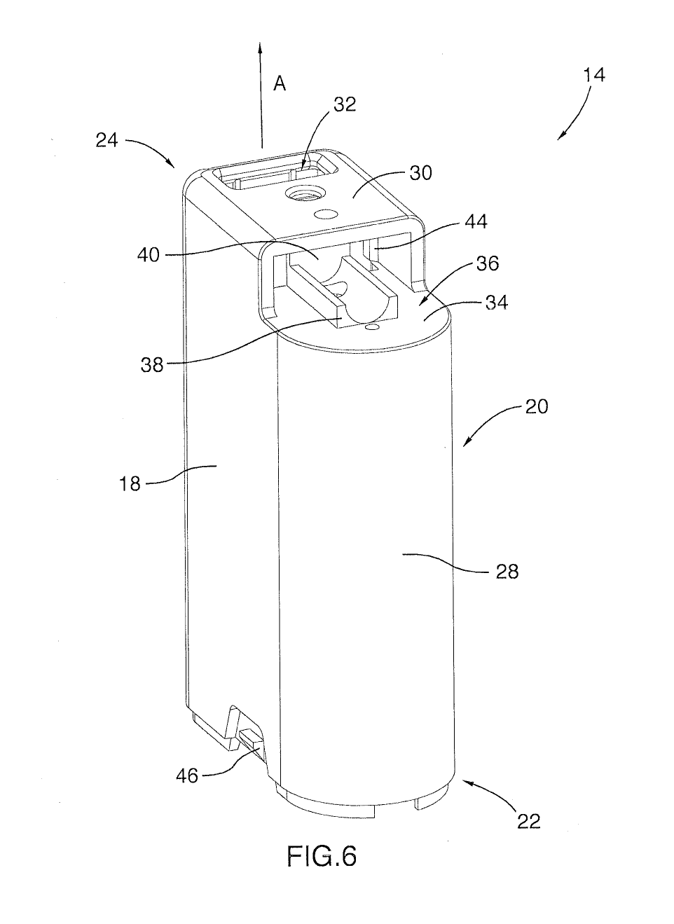

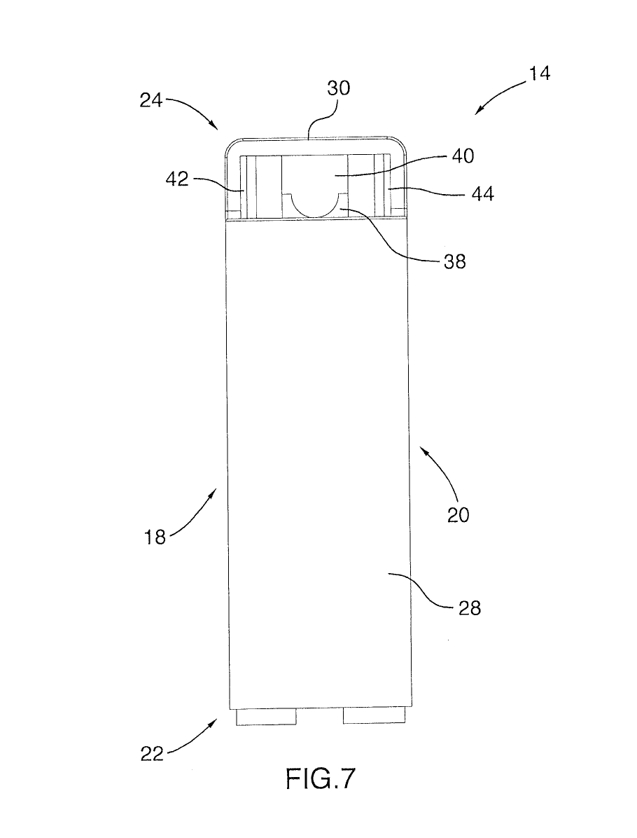

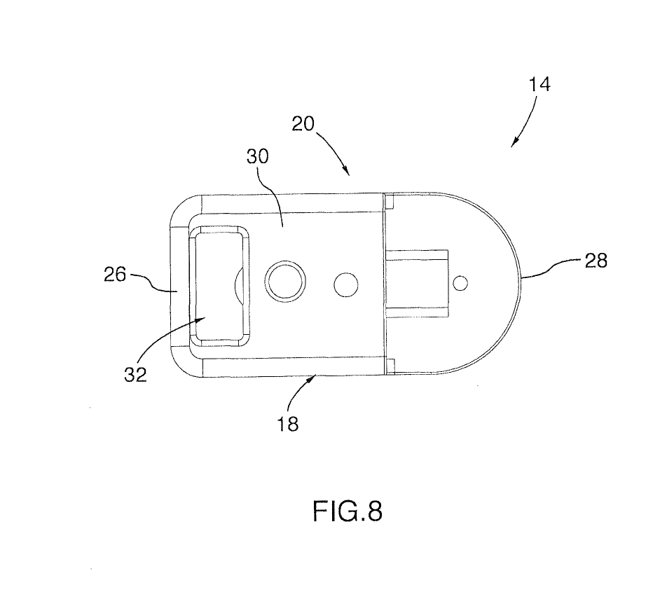

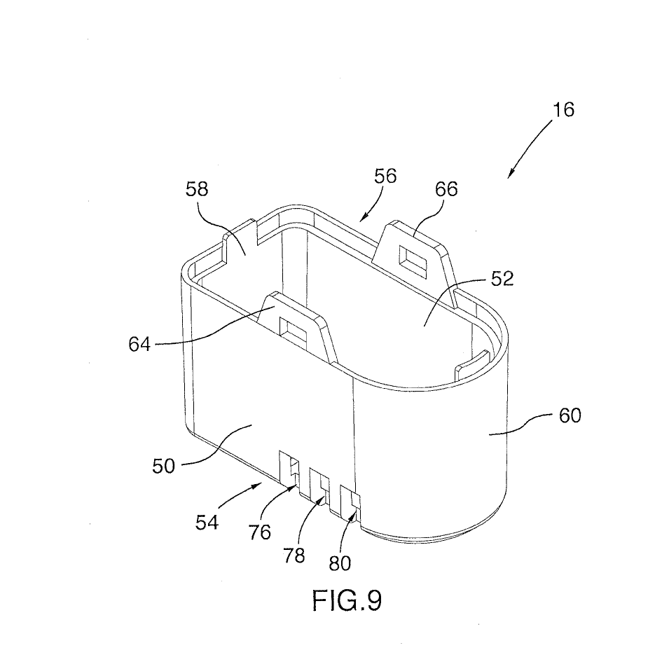

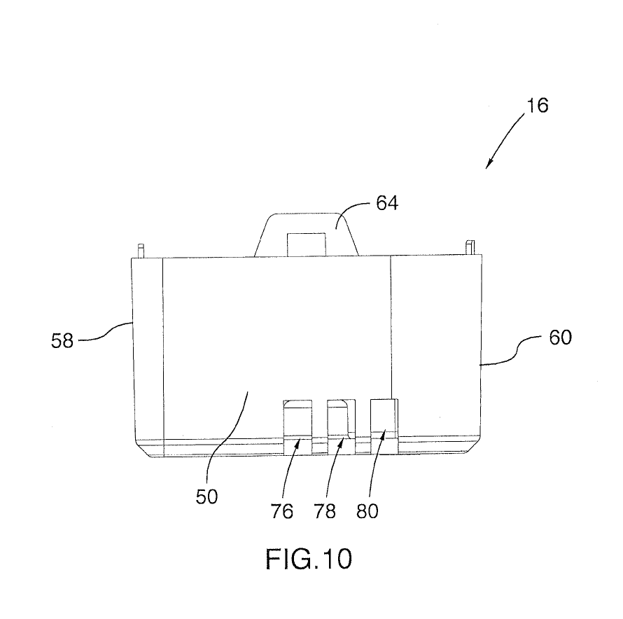

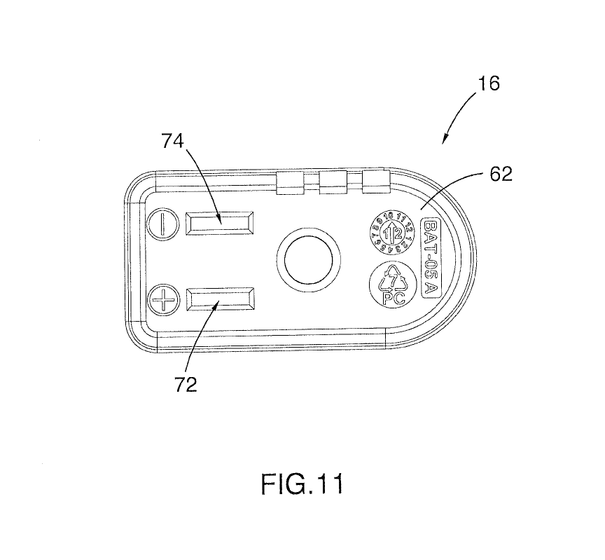

The battery pack 10 includes a body or frame 12 forming a protective outer shell for the battery pack 10. The body 12 may have a variety of shapes. In the illustrated embodiment, the body 12 comprises a first frame section 14 illustrated in FIGS. 6 to 8, and a second frame section 16 removably connectable to the first frame section 14 and illustrated in FIGS. 9 to 11. The first frame section 14 extends longitudinally along an axis A. The first frame section 14 comprises two opposite and parallel planar walls 18 and 20 which each extend longitudinally along the axis A between a bottom end 22 and a top end 24. The planar walls 18 and 20 each extend transversally along a given width and the width of the planar walls 18 and 20 varies along the length thereof. The planar wall 18, 20 comprises a first portion adjacent the bottom end 22 having a first width, i.e. the large width portion, and a second portion adjacent the top end 24 having a second width, i.e. the short width portion, the first width being greater than the second width.

The first frame section 14 further comprises a rear planar 26 wall and a front curved wall 28. The rear planar wall 26 extends longitudinally along the axis A and has the same length as that of the planar walls 18 and 20. The rear wall 26 is connected to the rear ends of the planar walls 18 and 20 to form an assembly having a U-shaped cross-section. The front wall 28 extends longitudinally from the bottom end 22 of the first frame section 14 and has a length that is substantially equal to the length of the large width portion of the walls 18 and 20. The front wall 28 is connected to the front ends of the large width portion of the walls 18 and 20.

The first frame section 14 also comprises a top wall 30 extending transversally and having a substantially rectangular shape. The top wall 30 has a length that is substantially equal to the width of the short width portion of the side walls 18 and 20 and a width which is substantially equal to the width of the rear wall 26. The top wall 30 is connected to the top end of the rear wall 26 and the top ends of the short width portions of the side walls 18 and 20. The top wall 30 comprises a rectangular aperture 32 therethrough. The rectangular aperture 32 is shaped and sized so as to receive a USB key therein.

A transverse planar wall 34 is connected to the top end of the front curved wall 28 and the top ends of the large width portions of the side walls 18 and 20. The planar wall 34 comprises a first curved section that covers the curved wall 28 and a substantially rectangular section that covers the top ends of the large width portion of the side walls 18 and 20. The rectangular section further extends below the top wall 30 along a given distance. The top surface 36 of the planar wall 34, which faces the top wall 30, comprises a U-shaped protrusion 38 which each extends along a portion of the length of the planar wall 34. The U-shaped protrusion 38 is shaped and sized to receive a spring therein, as described below.

A blocking wall 40 extends from the top surface 36 of the planar wall 34 to the top wall 30. The blocking wall 40 is sized, shaped and positioned for preventing any movement of the spring when inserted in the U-shaped protrusion 38. In the illustrated embodiment, the blocking wall 40 is positioned behind the U-shaped protrusion 38 while being secured thereto and has the same width as the U-shaped protrusion 38.

The first frame section 14 further comprises two blocking protrusions 42 and 44. The blocking protrusion 42 protrudes from the internal surface short width portion of the side wall 18 and extends from the planar wall 34 to the top wall 30. The blocking protrusion 44 protrudes from the internal surface short width portion of the side wall 20 and extends from the planar wall 34 to the top wall 30. The blocking protrusions 42 and 44 are positioned so as to face each other.

The first frame section 14 is also provided with two hook protrusions 46 and 48 each located in a recess present in their respective side wall 18, 20 for allowing the second frame section 16 to be secured thereto. The hook protrusion 46 protrudes from the external surface of the side wall 18 and is located adjacent the bottom end 22 thereof. The hook protrusion 48 protrudes from the external surface of the side wall 20 and is located adjacent the bottom end 22 thereof.

The second frame section 16 comprises two opposite and parallel planar walls 50 and 52 which each extend longitudinally along the axis A between a bottom end 54 and a top end 56. The second frame section 16 further comprises a rear planar 58 wall and a front curved wall 60. The rear planar wall 58 extends longitudinally along the axis A and has the same length as that of the planar walls 50 and 52. The rear wall 58 is connected to the rear ends of the planar walls 50 and 52 to form an assembly having a U-shaped cross-section. The front curved wall 60 extends longitudinally from the bottom end 54 of the second frame section 16 and has the same length as that of the planar walls 50 and 52. The curved front wall 60 connects the two side walls 50 and 52 together. The second frame section 16 also comprises a bottom wall 62 extending transversally and being connected to the side walls 50 and 52 and the rear and front walls 58 and 60.

The second frame section 16 further comprises two V-shaped protrusions 64 and 66 extending from the top end of the planar wall 50 and 52, respectively, and forming the holes 68 and 70. The holes 68 and 70 are shaped and sized to receive the hook protrusions 46 and 48 therein and thereby removably secure the first and second frame sections 14 and 16 together.

The bottom wall 62 is provided with two parallel and rectangular apertures 72 and 74 which are located adjacent the rear wall 58. The apertures 72 and 74 are shaped, sized and positioned so as to allow electrical terminals of a power plug to pass therethrough. The side wall 50 comprises three rectangular apertures 76, 78, and 80 which each partially extend through the bottom wall 62 and the aperture 80 partially extends through the curved front wall 60. The apertures 76. 78, and 80 are shaped, sized and positioned so as to receive therein electrical terminals.

It should be understood that the cross-section of the first and second frame sections 14 and 16 along a plane orthogonal to the axis A are substantially identical.

In one embodiment, the body 12 may be made of any adequate material such as a substantially rigid material. For example, the body 12 may be made of plastic.

In one embodiment, the body 12 may be made of a smooth material to facilitate sliding in and out of the battery pack 10 off a corresponding slot in a receiving electrical device to be charged or powered.

The battery pack 10 further comprises a locking mechanism 90 to releasably lock the battery pack 10 when it is inserted in a corresponding receiving slot of an electrical device to be powered or charged, so that the device can be used with the battery 10 secured therein for example.

The locking mechanism 90 comprises a spring (not shown) and a locking body or slidable tab 92. The locking body 92 comprises a semi-cylindrical section 94 comprising a planar side surface 96 and a curved side surface 98. The locking body 92 also comprises a rectangular section 100 projecting from the planar surface 96 of the semi-cylindrical section 94. Two arms 102 and 104 each extend from the rectangular section 100 opposite to the semi-cylindrical section 94, and each terminate with a respective hook 106, 108. The hooks 106 and 108 are shaped and sized to engage the blocking protrusions 42 and 44. The locking body 92 further comprises a lip 110 projecting outwardly from the curved side surface 98 of the semi-cylindrical section 94.

As illustrated in FIG. 1, when the locking mechanism 90 is connected to the body 12, the spring is positioned in compression within the U-shaped protrusion 38 and abuts against the blocking wall 40 at one end and against the rectangular section 100 at the other end. The arms 102 and 104 and part of the rectangular section 100 are inserted into the cavity 106 formed by the side walls of the short width section and the top wall.

The locking body 92 is movable between an extended position and a retracted position. When in the extended position, the hooks 106 and 109 abuts against the blocking protrusions 42 and 44 under the effect of the compressed spring which biases the locking body 92 into the extended position, and the curved surface 98 is coplanar with the curved wall 28. The lip 110 extend outwardly away from the curved wall 28. Part of the rectangular section 100 is outside the cavity 112 formed by the side walls of the short width section and the top wall.

When a force according to direction B is exerted on the locking body 92, the locking body 92 moves according to direction B and the whole rectangular section 100 penetrates into the cavity 112 and the semi-cylindrical section 94 abuts against the top wall and the short width portions of the side walls. The spring is then further compressed and the locking body 92 is in the retracted position. In this position, the lip 110 no longer extends outwardly away from the side wall 28.

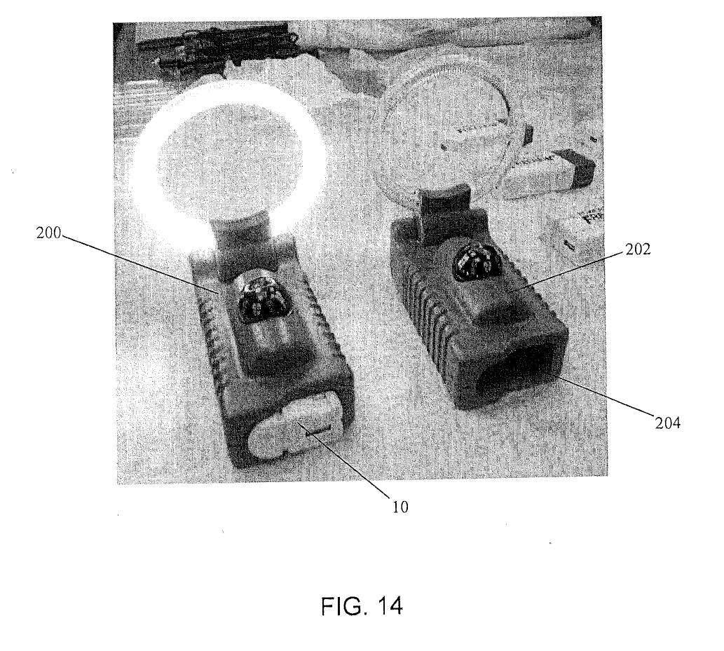

The lip 110 is engageable in a corresponding recess of a battery receiving slot present on the device to be charged or powered so as to effectively lock the battery pack 10 into the device to be charged or powered. Referring to FIG. 14, there is illustrated a portable light device 200 in which a battery pack 10 is inserted and removably secured, and a further battery pack 202 comprising no battery pack 10. The portable light device 200, 202 comprises a battery receiving slot 204 adapted to receive the battery pack 10 and to have the battery pack 10 removably secured thereto. In order to power the portable light device 200, 2012, the battery pack 10 is inserted into the battery receiving slot 204 and a force is exerted on the top wall 30 of the battery pack 10 to retract the locking body 92 until it abuts against the top wall 30. When the locking body 92 is retracted, the lip 110 may enter into the battery receiving slot 204 of the portable light device 200, 202. Once in the battery receiving slot 204, the spring of the locking mechanism 90 pushes back the locking body 92 into its extended position and the lip 110 extends from the front wall 28 of the battery pack 10 and prevents the battery pack 10 from being removed from the light portable device 200, 202 by abutting against the bottom wall of the slot 204 of the light portable device 10. The battery pack 10 is then removably secured within the portable light device 200, 202.

In order to remove the battery pack 10 from the portable light device 200, 202, a force is exerted on the locking body 92 so as to move the locking body 92 towards the top wall 30 and retract the lip 110. Once the lip 110 has been retracted, the battery pack 10 can be removed from the portable light device 200, 202.

In one embodiment, the battery pack is at least partially insertable into a power source device such as a battery charger. The battery charger comprises a battery receiving slot similar to the battery receiving slot 204 of the portable light device 200, 202. An electrical connector mating the electrical connector formed of the terminals 76-80 is inserted into the battery receiving slot of the battery charger so that the electrical connector is connected to the terminals 76-80 when the battery pack is inserted into the battery receiving slot of the battery charger. The rechargeable batteries 308 of the battery pack 10 can then be charged by the battery charger. The insertion of the battery pack 10 and the securing of the battery pack 10 into the battery receiving slot of the battery charger is similar to those for the portable light device 200, 202.

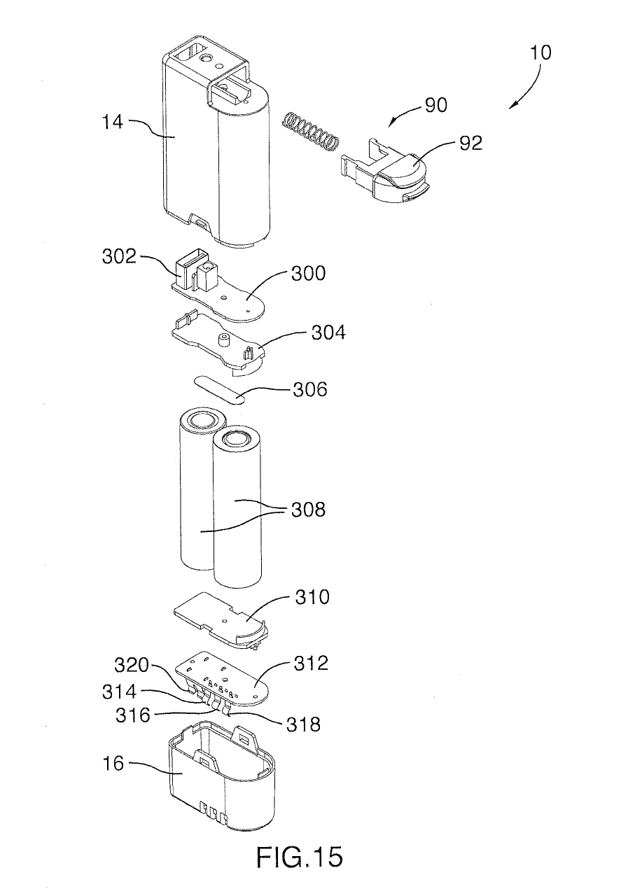

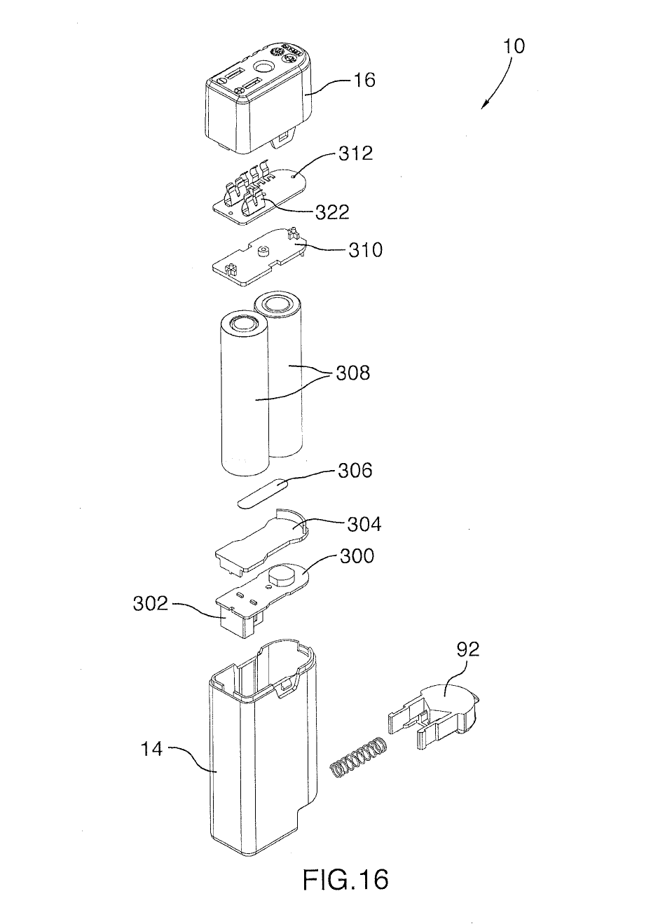

As illustrated in FIGS. 15 and 16, the battery pack 10 comprises a first Printed Circuit Board Assembly (PCBA) 300 on which a USB port 302 is connected. The USB port 302 is positioned on the PCBA 300 so as to face the aperture 32 and so that a USB connector be connected thereto. The battery pack further comprises a first plate 304, a first mylar film 306, two batteries 308, a second mylar film (not shown), a second plate 310, a second PCBA 312, five electrical terminals 314-322 which are connected to the second PCBA 312.

The mylar films act as a light protector and an insulator and are positioned at the end of the batteries 308. The fixed plates 304 and 310 connect on one end the mylar films to the batteries 308 and on the other end, the PCBAs 300 and 312 to the assembly of the battery unit 308 with the mylar films.

The three electrical terminals 314, 316, and 318 form together an electrical connector and are each positioned to face a respective aperture 76, 78, and 80. The electrical terminals are electrically connected to the PCBA 312 and are used for charging the batteries 308. The electrical terminals 314, 313, and 316 correspond to a positive, neutral, and a negative electrical terminal. When the electrical terminals 314, 316, and 318 are connected to mating electrical terminals of a power source or a battery charger (e.g. power grid, car lighter), the PCBA is adapted to charge the batteries 308 using the electrical power received from the power source. When the three electrical terminals 314, 316, and 318 are disconnected from the mating charging terminals, the battery pack 10 keeps its charge and may be used to power electrical devices such as the portable light device 200, 202.

While the apertures 76, 78, and 80, and therefore the electrical terminals 314, 316, and 318, are located at the bottom end of the battery pack 10, it should be understood that other configurations are possible. It should also be understood that the shape and size of the apertures 76, 78, and 80 and the electrical terminals 314, 316, and 318 may vary as long as the electrical terminals 314, 316, and 318 electrically connect with the electrical terminals of the power source or battery charger.

The terminals 320 and 322 form together an electrical connector and are positioned on the PCBA 312 so as to each face a respective aperture 72, 74. The electrical terminals 320 and 322 are electrically connected to the PCBA 312 and are used for transferring electrical power from the batteries 308 to an electrical device to be charged. When the electrical terminals 320 and 322 are connected to mating electrical terminals of the device to be charged, the PCBA is adapted to charge the electrical device using the electrical power contained in the batteries 308. When the two electrical terminals 320 and 322 are disconnected from the mating terminals, the battery pack 10 keeps its remaining charge and may be used to power or charge electrical devices such as the portable light device 200, 202.

While the apertures 72 and 74, and therefore the terminals 320 and 322, are located at the bottom end of the battery pack 10, it should be understood that other configurations may be possible. The shape and size of the apertures 72 and 74 and the terminals 320 and 322 may vary as along as the terminals 320 and 322 are connectable to mating connectors of the first electrical device.

It should be understood that the batteries 308 are electrically connected to the USB port 302, the electrical terminals 314-318, and the electrical terminals 320 and 322. In one embodiment, the PCBA 300 is adapted to open and close the electrical connection between the USB port 302 and the batteries 308. In one embodiment, the PCBA 312 is adapted to open and close the electrical connection between the terminals 320 and 3222 and the batteries 308. In the same or another embodiment, the PCBA 312 is adapted to open and close the electrical connection between the terminals 314-318 and the batteries 308.

While the present description refers to two PCBAs 300 and 312 for controlling the charging of the rechargeable batteries 308 and the powering of the electrical devices, it should be understood that any adequate control unit may be used. For example, the battery pack 10 may comprise a single PCBA.

In one embodiment, the electrical terminals 320 and 322 are shaped and sized to receive electrical terminals of a device functioning at about 7.4 V.

In one embodiment, the USB port 302 is used to charge an electrical device operating under about 5 V, such as a cellular phone.

In one embodiment, the battery pack 10 may be used for concurrently powering two different electrical devices using the USB port 302 and the electrical terminals 320 and 322. For example, the battery pack 10 may be inserted into an electrical device such as the portable light device 200 to power the portable light device 200 and a cellular phone may be connected via a USB cable to the USB port of the battery pack 10. In this case, both the portable light source and the cellular phone may be concurrently powered by the battery pack 10.

In one embodiment, the rechargeable batteries 308 of the battery pack 10 may be recharged while the battery pack 10 is used for powering an electrical device. For example, the electrical terminals 314, 316, 320 may be connected to terminals of a power source adapted to recharge the batteries 308 and the USB port 302 may be connected to a cellular phone via a USB cable to power the cellular phone.

While the illustrated battery pack 10 comprises a single USB port 302 and a single connector formed of the terminals 320 and 322, it should be understood that the number and location of the USB ports may vary and the number and location of the connectors formed of terminals 320 and 3222 may vary.

In operation, the PCBA 300 is adapted to detect any connection between the USB port 302 and a USB connector connected to a device to be powered, i.e. it is adapted to detect when a USB connector is inserted into the USB port 302. Upon detection of the connection, the PCBA 300 is adapted to transfer electrical power from the batteries 308 to the device to be powered by powering the USB port 302. As a result of the powering of the USB port 302, the device connected to the USB port 302 is powered.

The PCBA 312 is adapted to detect any connection between the terminals 320 and 322 and matching terminals of a device to be powered. Upon detection of the electrical connection, the PCBA 312 is adapted to transfer electrical power from the batteries 308 to the device to be powered by powering the terminals 320 and 322. As a result of the powering of the terminals 320 and 322, the device connected to the terminals 320 and 322 is powered.

The PCBA 312 is further adapted to detect any connection between the terminals 314-318 and matching terminals of a power source. Upon detection of the electrical connection, the PCBA 312 is adapted to transfer electrical power received from the terminals 314-318 to the batteries 308 to recharge them.

In one embodiment, the PCBAs 300 and 312 are adapted to cooperate together to concurrently power a first electrical device connected to the terminals 320 and 322 and a second electrical device connected to the USB port 302.

In the same or another embodiment, the PCBAs 300 and 312 are adapted to cooperate together to concurrently charge the batteries 308 using electrical power received from the terminals 314-318 and power a first electrical device connected to the USB port.

The above description is meant to be exemplary only, and one skilled in the art will recognize that changes may be made to the embodiments described without departing from the scope of the invention disclosed. Other modifications which fall within the scope of the present invention will be apparent to those skilled in the art, in light of a review of this disclosure, and such modifications are intended to fall within the appended claims.

1. A battery pack comprising:
a body removably connectable to a first electrical device and a second electrical device;
a rechargeable battery unit disposed inside the body;
a charging connector formed in the body and electrically connected to the battery unit, the charging connector being connectable to a power source for charging the battery unit;
a power connector formed in the body and being electrically connected to the rechargeable battery unit, the power connector being connectable to the first electrical device for transferring electrical power from the rechargeable battery unit to the first electrical device;
a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and
a control unit for charging the rechargeable battery unit when the charging connector is connected to the power source and for transferring electrical power to at least one of the power connector and the USB port when the battery pack is connected to at least one of the first and second electrical devices, respectively.

2. The battery pack as claimed in claim 1, wherein the battery unit comprises a lithium ion battery unit.

3. The battery pack as claimed in claim 1, wherein the power connector is at least one pin receiving slot.

4. The battery pack as claimed in claim 3, wherein the at least one pin receiving slot comprises two rectangular slots.

5. The battery pack as claimed in claim 1, wherein the power connector is disposed on a bottom of the body, and the USB port is disposed on a top of the body.

6. The battery pack as claimed in claim 1, wherein the body has a rectangular shape.

7. The battery pack as claimed in claim 1, wherein the charging connector is disposed on the bottom of the body adjacent to the power connector.

8. The battery pack as claimed in claim 1, further comprising a locking mechanism disposed on the body, the locking mechanism being designed for securing the battery pack to the first device.

9. The battery pack as claimed in claim 8, wherein the locking mechanism includes a tab slidable between an extended position and a retracted position, and a lip projecting from the tab, when in the extended position the lip being adapted to engage a corresponding recess wall of a battery receiving slot of the first device, when in the retracted position the lip being adapted to disengage the corresponding recess wall of the battery receiving slot of the first device.

10. The battery pack as claimed in claim 8, wherein the locking mechanism is spring loaded.

11. The battery pack as claimed in claim 1, wherein the first electrical device is a portable light device and the second electrical device is a cellular phone.

12. An assembly comprising:
a power source device having a battery receiving slot and an electrical connector disposed in the battery receiving slot; and
a battery pack removably insertable at least partially in the battery receiving slot of the power source device, the battery pack comprising:
a body at least partially insertable into the battery receiving slot of the power source device and connectable to a first electrical device and a second electrical device;
a rechargeable battery unit disposed inside the body;
a charging connector formed in the body and electrically connected to the battery unit, the charging connector being connectable to the electrical connector of the power source device for charging the rechargeable battery unit;
a power connector formed in the body and being electrically connected to the rechargeable battery unit, the power connector being connectable to the first electrical device for transferring electrical power from the rechargeable battery unit to the first electrical device;
a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and
a control unit for charging the rechargeable battery unit when the charging connector is connected to the power source and for transferring electrical power to at least one of the power connector and the USB port when the battery pack is connected to at least one of the first and second electrical devices, respectively.

13. The assembly as claimed in claim 12, wherein the battery unit comprises a lithium ion battery unit.

14. The assembly as claimed in claim 12, further comprising a locking mechanism disposed on the body, the locking mechanism for removably securing the battery pack to the power source device.

15. The assembly as claimed in claim 12, wherein the power source device is a battery charger, the first electrical device is a portable light device, and the second electrical device is a cellular phone.

16. An assembly comprising:
a first electrical device having a battery receiving slot and an electrical connector disposed in the battery receiving slot; and
a battery pack removably insertable in the battery receiving slot of the first portable device, the battery pack comprising:
a body at least partially insertable into the battery receiving slot of the first electrical device and electrically connectable to the first electrical device and a second electrical device;
a rechargeable battery unit disposed inside the body;
a charging connector formed in the body and electrically connected to the battery unit, the charging connector being connectable to a power source device for charging the rechargeable battery unit;
a power connector formed in the body and being electrically connected to the rechargeable battery unit, the power connector being connectable to the electrical connector of the first electrical device for transferring electrical power from the rechargeable battery unit to the first electrical device;
a USB port formed in the body and being electrically connected to the rechargeable battery unit, the USB port being connectable to the second electrical device for transferring electrical power from the rechargeable battery unit to the second electrical device, the USB port being positioned away from the power connector so that the battery pack be concurrently connectable to the first electrical device via the power connector and to the second electrical device via the USB port; and
a control unit for charging the rechargeable battery unit when the charging connector is connected to the power source and for transferring electrical power to at least one of the power connector and the USB port when the battery pack is connected to at least one of the first and second electrical devices, respectively.

17. The assembly as claimed in claim 16, wherein the battery unit comprises a lithium ion battery unit.

18. The assembly as claimed in claim 16, further comprising a locking mechanism disposed on the body, the locking mechanism being designed for removably securing the battery pack to the first electrical device.

19. The assembly as claimed in claim 16, wherein the first portable device is a portable light device and the second portable device is a cellular phone.
